(19) United States
(12) Patent Application Publication
(10) Pub. No.: US 2025/0051002 A1
(43) Pub. Date: Feb. 13, 2025

(54) VARIABLE-DIAMETER BLADE SUITABLE FOR TRANS-MEDIA AIRCRAFT

(71) Applicant: Nanjing University of Aeronautics and Astronautics, Nanjing City (CN)

(72) Inventors: Xi CHEN, Nanjing City (CN); Qijun ZHAO, Nanjing City (CN); Fan YANG, Nanjing City (CN); Muyang LIN, Nanjing City (CN); Guoqing ZHAO, Nanjing City (CN); Xiayang ZHANG, Nanjing City (CN); Bo WANG, Nanjing City (CN); Kaixuan HUANG, Nanjing City (CN)

(21) Appl. No.: 18/799,421

(22) Filed: Aug. 9, 2024

(30) Foreign Application Priority Data
Aug. 9, 2023 (CN) 202311002781.3

(51) Int. Cl. B64C 3/54; B64C 35/00

(52) U.S. Cl. CPC B64C 3/54; B64C 35/006

(57) ABSTRACT

A variable-diameter blade suitable for a trans-media aircraft. The blade is divided into a blade root section, telescopic sections, and a blade tip section in a direction from the root to the tip. The blade further includes a telescopic rod, the blade root section and the blade tip section are fixed to the telescopic rod, respectively, and the telescopic rod is fixed to the trans-media aircraft; a spring arranged in the telescopic rod, the spring is used to drive the telescopic rod to extend; a pulley installed on the trans-media aircraft, the pulley is closer to the blade root section; a pull rope, an end of the pull rope passes through an inside of the blade and is fixed to the blade tip section, and the other end of the pull rope is wound on the pulley; and a driving device for driving the pulley to rotate.

### CROSS-REFERENCE TO RELATED APPLICATION

This patent application claims the benefit and priority of Chinese Patent Application No. 202311002781.3 filed with the China National Intellectual Property Administration on Aug. 9, 2023, the disclosure of which is incorporated by reference herein in its entirety as part of the present application.

### TECHNICAL FIELD

The present disclosure relates to the technical field of aircrafts, and in particular to a variable-diameter blade suitable for a trans-media aircraft.

### BACKGROUND

Trans-media aircraft combines the concepts of submersible and aircraft, which has both function of the submersible and aircraft and ability to freely cross the water-air interface, and can meet requirements of various multi-media complex tasks. However, the water and air have quite different physical properties, such as density and viscosity, so it is necessary to design a shape of a rotor to take into account performance of the trans-media aircraft in air/water medium.

At present, the rotor-based trans-media aircrafts generally solve problems caused by the difference of air and water environments through two schemes: one is that an aerial propeller is used both in the air and underwater, the rotor can work normally in the air, and when working underwater, rotating speed of the rotor is greatly reduced to obtain better working efficiency, such as Loon Copter of the University of Auckland. The other is that the aerial propeller is used in the air, and a water propeller is used underwater, and the aerial propeller and the water propeller run independently, such as a double-layer quad rotor trans-media aircraft of Air Force Engineering University.

Taking loon Copter of the University of Auckland as an example, the power is obtained by aerial propeller in the air and underwater, and only aerodynamic performance of blades in the air is considered, but a special shape of the rotor underwater is not optimized. Therefore, when the aircraft is underwater, the rotor can work only at an extremely low rotating speed to obtain better working efficiency, leading to poor underwater performance of the aircraft. Taking the double-layer four-rotor trans-media aircraft of Air Force Engineering University as an example, four aerial propellers at an upper layer are used when the aircraft is in the air, and four water propellers at a lower layer are used when the aircraft is underwater, which makes the aerial propellers and water propellers work best in their respective operating environments. However, the aerial propellers greatly increase resistance when the aircraft navigates underwater, and a whole water propeller system has become a deadweight when the aircraft flies in the air.

Visibly, the problems caused by the difference of water and air environments cannot be solved in the prior art, and the water and air performance of the trans-media aircraft cannot be considered at the same time.

### SUMMARY

An objective of the present disclosure is to provide a variable-diameter blade suitable for a trans-media aircraft, so as to solve the problems in the prior art. The variable-diameter blade gives consideration to both the water and air performance of the trans-media aircraft, and can reduce influence on the aerodynamic performance of a rotor as much as possible while improving hydrodynamic performance of the rotor.

To achieve the objective above, the present disclosure adopts the following technical solution:

The present disclosure provides a variable-diameter blade suitable for a trans-media aircraft. The variable-diameter blade is divided into multiple sub-blades in a direction from a root to a tip, and all the sub-blades are named as blade root section, telescopic section and blade tip section in turn from the root to the tip. The telescopic section includes several telescopic sections are arranged, the blade root section includes one blade root section, and the blade tip section includes one blade tip section. Any two closer sub-blades except the blade tip section are in sliding fit, and the sub-blade, closer to the blade tip section, of the any two closer sub-blades except the blade tip section can be accommodated in the other sub-blade of the any two adjacent sub-blades, and the blade tip section is fixedly connected to the telescopic section which is closer to the blade tip section. The variable-diameter blade further includes:
a telescopic rod partially located in the variable-diameter blade, the blade root section and the blade tip section each are fixedly connected to the telescopic rod, respectively, and the telescopic rod is fixedly connected to the trans-media aircraft;
a spring arranged in the telescopic rod, the spring is used to drive the telescopic rod to extend to a maximum length;
a pulley installed on the trans-media aircraft, the pulley is closer to the blade root section and has a gap with the blade root section;
a pull rope, where an end of the pull rope passes through an inside of the variable-diameter blade and is fixedly connected to the blade tip section, and an other end of the pull rope is wound around the pulley; and
a driving device for driving the pulley to rotate.

A leading edge of the blade root section is a curve, and a trailing edge of the blade root section is a straight line. A leading edge and a trailing edge of the blade tip section are both straight lines.

Preferably, an outer wall of an end, closer to the blade root section, of each telescopic section is provided with an outer convex ring, inner walls of both ends of the blade root section and each telescopic section are provided with first limit rings and second limit rings, respectively. The first limit ring is closer to the root, and the second limit ring is closer to the tip. The outer convex ring on the sub-blade, closer to the blade tip segment, of any two closer sub-blades except the blade tip section is configured for being abutted against the first limit ring or the second limit ring on the other sub-blade of the any two adjacent sub-blades.

Preferably, an axis of the telescopic rod is coaxial with a variable blade pitch axis of the variable-diameter blade. A length direction of a part of the pull rope located in the variable-diameter blade is parallel to an axial direction of the telescopic rod.

Preferably, when all telescopic sections are located in the blade root section, an outer wall of an end, closer to the blade root section, of the blade tip section is in smooth transition connection with an end, closer to the blade tip section, of the blade root section. A blade composed of the blade root section and the blade tip section is configured as a blade for an underwater mode.

When a length of the variable-diameter blade is in a longest state, the blade is configured as a blade for an aerial mode.

Preferably, a shape of the blade root section is designed according to a situation that the trans-media aircraft navigates in the water.

Compared with the prior art, the present disclosure has the following technical effects:

The variable-diameter blade suitable for a trans-media aircraft gives consideration to both water and air performance of the trans-media aircraft, and on the basis of ensuring the aerodynamic performance of a rotor, the hydrodynamic performance of the rotor is improved.

Specifically, the variable-diameter blade suitable for the trans-media aircraft has two forms through length change of the blade, which are an aerial mode shape and an underwater mode shape, respectively. The blade in the aerial mode shape is configured to a complete designed length, and is no difference from a blade of a rotor of an ordinary helicopter when flying in the air. A length of the blade in the underwater mode shape is greatly reduced after diameter change, such that the blade is more suitable for the underwater environment, and meanwhile, the rotating speed and efficiency are higher than those of a blade of a conventional rotor working underwater.

CFD (computational fluid dynamics) calculation indicates that the rotor can obtain better performance when the rotating speed is extremely low underwater, but this scheme will lead to the great difference between the rotating speeds of the rotor in the air and underwater, design difficulty of the transmission system is improved, and a working mode with low rotating speed also limits the underwater cruising speed of the trans-media aircraft. The CFD calculation also indicates that when the rotor works underwater, a pressure distribution on a blade surface is more uniform along a spanwise than in the air, and the root of the blade can play a greater role underwater. Therefore, by reducing the length of the blade of the rotor when working underwater, the efficiency can be further improved while increasing the rotating speed.

In the aerial mode, velocity of relative inflow near the blade root is small, which has little influence on overall aerodynamic performance. Therefore, the shape near the blade root can be designed separately for the underwater cruising state, so as to improve the underwater performance. The aerodynamic performance of the blade is mainly affected by the shape from a middle section of the blade (i.e., each telescopic section) to the tip of the blade. However, when in the underwater mode, this section is retracted into the blade root section, and does not affect the underwater performance of the blade. Therefore, the shape from the middle section of the blade to the tip of the blade can be designed independently for an aerial working state, so to improve the aerodynamic performance.

In conclusion, according to this scheme, the rotor can give consideration to both aerodynamic performance and hydrodynamic performance, which solves the problems caused by the difference of water and air environments and is suitable for the trans-media aircraft.

### BRIEF DESCRIPTION OF THE DRAWINGS

To describe the technical solutions of the embodiments of the present disclosure or in the prior art more clearly, the following briefly introduces the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a structural diagram of a variable-diameter blade suitable for a trans-media aircraft according to the present disclosure in an aerial mode;

FIG. 2 is a structural diagram of a variable-diameter blade suitable for trans-media aircraft according to the present disclosure in an underwater mode;

FIG. 3 is a structural diagram of a first telescopic section in a variable-diameter blade suitable for trans-media aircraft according to the present disclosure;

FIG. 4 is a structural diagram of a second telescopic section in a variable-diameter blade suitable for trans-media aircraft according to the present disclosure;

FIG. 5 is a shape diagram of a blade root section and a blade tip section of a variable-diameter blade suitable for a trans-media aircraft according to the present disclosure;

FIG. 6 is a structural diagram of a variable-diameter blade suitable for a trans-media aircraft according to the present disclosure in an aerial mode.

In the drawings: 1—telescopic rod; 2—pulley; 3—root blade rib; 4—strip; 5—spring; 6—tip blade rib; 7—blade tip section; 8—first telescopic section; 9—second telescopic section; 10—third telescopic section; 11—blade root section; 12—outer convex ring; 13—first limit ring; 14—second limit ring; 15—blade variable pitch axis; 16—rotating axis.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

An objective of the present disclosure is to provide a variable-diameter blade suitable for a trans-media aircraft, so as to solve the problems in the prior art. The variable-diameter blade gives consideration to both the water and air performance of the trans-media aircraft, and can reduce the influence on the aerodynamic performance of a rotor as much as possible while improving the hydrodynamic performance of the rotor.

In order to make the objectives, features and advantages of the present disclosure more clearly, the present disclosure is further described in detail below with reference to the embodiments.

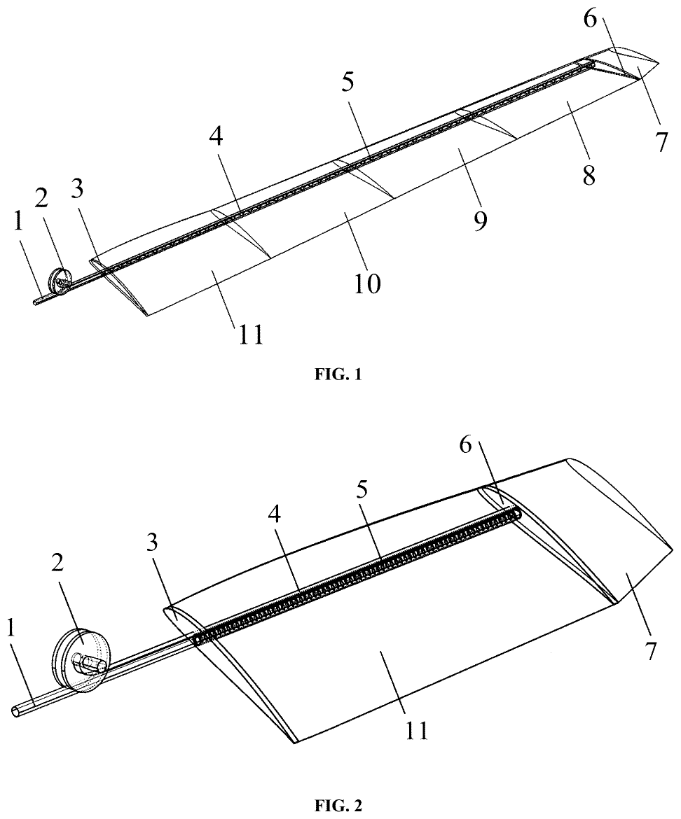

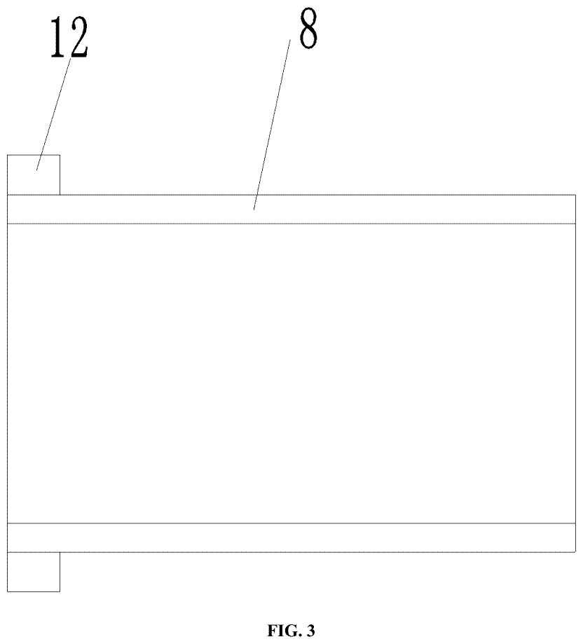

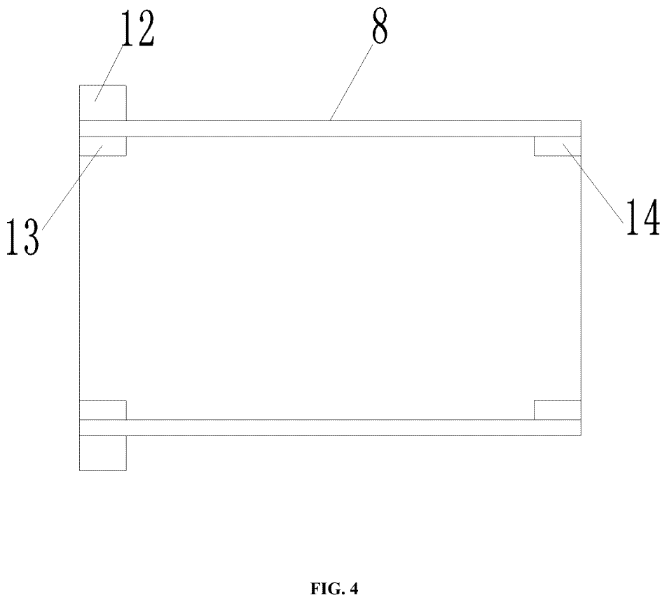

As shown in FIG. 1 to FIG. 4, a variable-diameter blade suitable for a trans-media aircraft is provided by this embodiment. The variable-diameter blade is divided into multiple sub-blades in a direction from a root to a tip. The multiple sub-blades are named as blade root section 11, telescopic section and blade tip section 7 in turn from the root to the tip. The telescopic section includes three telescopic sections, which are a first telescopic section 8, a second telescopic section 9, and a third telescopic section 10 in turn in a direction from the blade tip to the blade root. In practical application, the specific number of the telescopic sections can be adjusted according to actual demands, and the blade root section includes one blade root section 11 and the blade tip section includes one blade tip section 7. Any two closer sub-blades except the blade tip section 7 are in sliding fit, and the sub-blade, closer to the blade tip section 7, of the any two closer sub-blades except the blade tip section 7 can be accommodated in the other sub-blade of the any two adjacent sub-blades, and the blade tip section 7 is fixedly connected to the telescopic section, which is closer to the blade tip section 7.

The variable-diameter blade suitable for a trans-media aircraft in this embodiment further includes:
a telescopic rod 1 partially located in the variable-diameter blade, the blade root section 11 and the blade tip section 7 each are fixedly connected to the telescopic rod 1, respectively, and the telescopic rod 1 is fixedly connected to the trans-media aircraft; in this embodiment, the telescopic rod 1 is fixedly connected to a root blade rib 3 on the blade root section 11, and the telescopic rod 1 is fixedly connected to a tip blade rib 6 on the blade tip section 7;
a spring 5 arranged in the telescopic rod 1, the spring 5 is used to drive the telescopic rod 1 to extend to a maximum length;
a pulley 2 installed on the trans-media aircraft, the pulley 2 is closer to the blade root section 11 and has a gap with the blade root section 11;
a pull rope 4, an end of the pull rope 4 passes through an inside of the variable-diameter blade and is fixedly connected to the blade tip section 7, and an other end of the pull rope is wound around the pulley 2; and
a driving device for driving the pulley 2 to rotate, the driving device may adopt a servo motor.

In this embodiment, an outer wall of an end, closer to the blade root section 1, of each telescopic section is provided with an outer convex ring 12, and inner walls of both ends of the blade root section 11 and each telescopic section are provided with first limit rings 13 and second limit rings 14, respectively. The first limit ring 13 is closer to the root, and the second limit ring 14 is closer to the tip. The outer convex ring 12 on the sub-blade, closer to the blade tip section 7, of any two closer sub-blades except the blade tip section 7 is used for being abutted against the first limit ring 13 or the second limit ring 14 on the other sub-blade of the any two adjacent sub-blades.

In this embodiment, an axis of the telescopic rod 1 is coaxial with a blade variable pitch axis of the variable-diameter blade. A length direction of the part of the pull rope 4 located in the variable-diameter blade is parallel to an axial direction of the telescopic rod 1.

In this embodiment, specific principle of changing the diameter, that is, changing the length, of the variable-diameter blade suitable for the trans-media aircraft is as follows:

When the aircraft is switched to an underwater mode from an aerial mode, the pulley 2 is driven by a driving device to rotate, the pulley 2 pulls the tip blade rib 6 to the root blade rib 3 by the pull rope 4, and the blade tip section 7 drives the first telescopic section 8 to move towards the blade root. When the outer convex ring 12 on the first telescopic section 8 is abutted against the first limit ring 13 on the second telescopic section 9, the blade tip section 7 and the first telescopic section 8 drive the second telescopic section 9 to move towards the blade root. When the outer convex ring 12 on the second telescopic section 9 is abutted against the first limit ring 13 on the third telescopic section 10, the blade tip section 7, the first telescopic section 8 and the second telescopic section 9 drive the third telescopic section 10 to move towards the blade root until the outer convex ring 12 on the third telescopic section 10 is abutted against the first limit ring 13 on the blade root section 11. At this time, the telescopic rod 1 and the spring 5 are retracted, and the first telescopic section 8, the second telescopic section 9 and the third telescopic section 10 are driven by the telescopic rod 1 to retract into the blade root section 11, thus the diameter of the blade is reduced and the switching is completed.

When the aircraft is switched to the aerial mode from the underwater mode, the pulley 2 is free of power input, and the pull rope 4 cannot provide tension for the tip blade rib 6, and at this time, the spring 5 releases elastic potential energy to drive the telescopic rod 1 to extend. The telescopic rod 1 pushes the blade tip section 7 to move towards a direction away from the blade root through the tip blade rib 6. The blade tip section 7 drives the first telescopic section 8 to move towards a direction away from the blade root while moving. When the outer convex ring 12 on the first telescopic section 8 is abutted against the second limit ring 14 on the second telescopic section 9, the blade tip section 7 and the first telescopic section 8 drive the second telescopic section 9 to move towards a direction away from the blade root. When the outer convex ring 12 on the second telescopic section 9 is abutted against the second limit ring 14 on the third telescopic section 10, the blade tip section 7, the first telescopic section 8 and the second telescopic section 9 drive the third telescopic section 10 to move towards a direction away from the blade root until the outer convex ring 12 on the third telescopic section 10 is abutted against the second limit ring 14 on the blade root section 11. At this time, the telescopic rod 1 and the spring 5 are extended, the first telescopic section 8, the second telescopic section 9 and the third telescopic section 10 are driven by the telescopic rod 1 to extend out of the blade root section 11, thus the diameter of blade diameter is increased and the switching is completed.

CFD calculation indicates that when the rotor works underwater, a pressure distribution on a blade surface is more uniform along a spanwise than in the air, and the blade root can play a greater role underwater. Therefore, by reducing the length of the blade of the rotor when working underwater, the efficiency can be further improved while increasing the rotating speed.

In this embodiment, a shape of the blade root section 11 is designed according to a situation that the trans-media aircraft navigates in the water. Specifically, a leading edge of the blade root section 11 is a curve, and a trailing edge of the blade root section is a straight line. The variable-diameter blade is used as a blade for the aerial mode when the length thereof is the longest. While the first telescopic section 8, the second telescopic section 9, the third telescopic section 10 and the blade tip section 7 are all designed according to a situation that the trans-media aircraft navigates in the air, and their leading edges and trailing edges are all straight lines. A shape of a blade plane of each of the first telescopic section 8, the second telescopic section 9 and the third telescopic section 10 is rectangular.

In this embodiment, when all telescopic sections are located in the blade root section 11, an outer wall of an end, closer to the blade root section 11, of the blade tip section 7 is in smooth transition connection with an end, closer to the blade tip section 7, of the blade root section 11. A blade composed of the blade root section 11 and the blade tip section 7 forms a blade for the underwater mode.

In the aerial mode, velocity of relative inflow near the blade root is small, which has little influence on overall aerodynamic performance. Therefore, the shape near the blade root can be designed separately for the underwater cruising state, so as to improve the underwater performance. The aerodynamic performance of the blade is mainly affected by the shape from a middle section of the blade (i.e., each telescopic section) to the tip of the blade. However, when in the underwater mode, this section is retracted into the blade root section, and does not affect the underwater performance of the blade. Therefore, the shape from the middle section of the blade to the tip of the blade can be designed independently for an aerial working state, so to improve the aerodynamic performance.

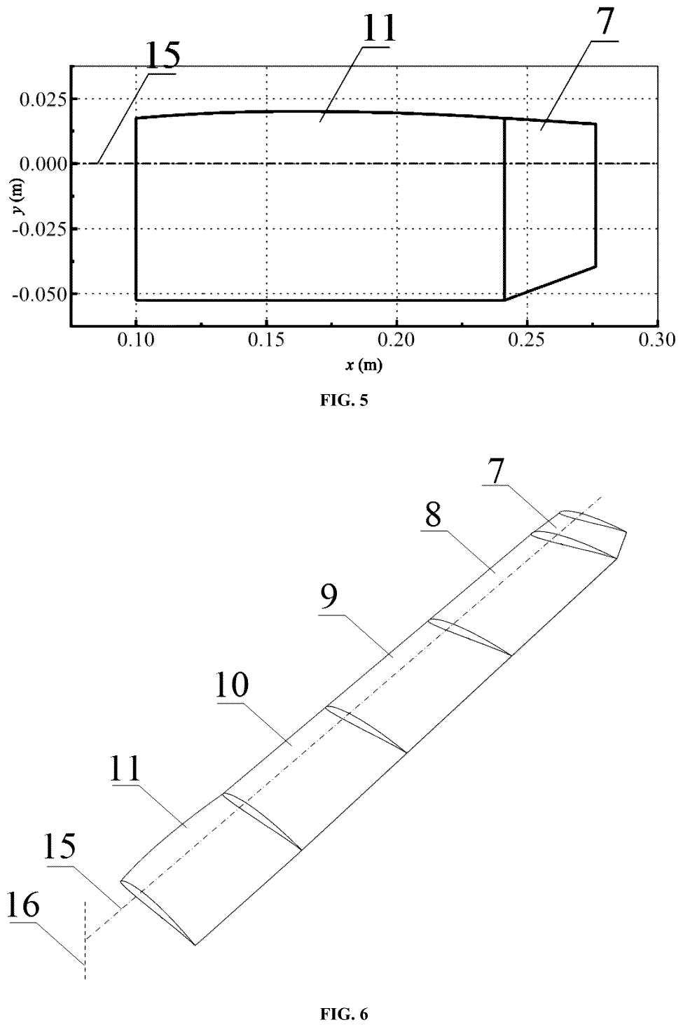

Referring to FIG. 5 and FIG. 6, in this embodiment, an intersection of a blade variable pitch axis 15 and a rotating axis 16 is used as an origin, the blade variable pitch axis 15 is used as the x axis and the rotating axis 16 is used as the y axis, a shape curve of the leading edge of the blade root section 11 is defined as:

$$f ( x ) = \{ \begin{matrix}- 0.72389 {( x - 0.16039 )}^{2} + 0.02014 & x ∈ [ 0.1 , 0.16039 ) \\ - 0.40377 {( x - 0.16039 )}^{2} + 0.02014 & x ∈ [ 0.16039 , 0.24125 )\end{matrix} .$$

A shape curve of the trailing edge of the blade root section 11 is defined as:

$$\begin{matrix}f ( x ) = - 0.0525 & x ∈ [ 0.1 , 0.24125 )\end{matrix} .$$

A shape curve of the leading edge of the blade tip section 7 is defined as:

$$f ( x ) = - 0.93486 ( x - 0.24125 ) + 0.0175 \qquad x ∈ [ 0.24125 , 0.27625 ]$$

A shape curve of the trailing edge of the blade tip section 7 is defined as:

$$\begin{matrix}f ( x ) = - 0.36943 ( x - 0.27625 ) - 0.05479 & x ∈ [ 0.24125 , 0.27625 ]\end{matrix} .$$

Airfoils of the blade tip section 7, the first telescopic section 8, the second telescopic section 9, the third telescopic section 10 and the blade root section 11 are all obtained by scaling a criterion airfoil A.

Chord lengths of the airfoils of the first telescopic section 8, the second telescopic section 9, the third telescopic section 10 and the blade root section 11 are 0.07 m, and a chord length of the airfoil of the blade tip section 7 is 0.05479 m.

A leading edge point of the blade is used as an origin, the blade variable pitch axis 15 is used as the x axis and the rotating axis 16 is used as the y axis, coordinates of the shape of the criterion airfoil A are shown in the following table.

TABLE 1
Coordinates of the shape of basic airfoil A
Criterion airfoil A
Maximum thickness: 10%, position of chord line: 26.6%
Maximum curvature: 3.4%, position of chord line: 45.1%

| | |
|---|---|
| Upper surface | Lower surface |

| X | Y | X | y |
|---|---|---|---|
| 0 | 0 | 0 | 0 |
| 0.00115 | 0.00448 | 0.00038 | −0.00223 |
| 0.00606 | 0.01293 | 0.00532 | −0.00701 |
| 0.01502 | 0.02206 | 0.01649 | −0.01088 |
| 0.02812 | 0.03145 | 0.03308 | −0.01403 |
| 0.04524 | 0.04078 | 0.05491 | −0.01635 |
| 0.06627 | 0.04976 | 0.0818 | −0.01787 |
| 0.09105 | 0.05809 | 0.11351 | −0.01862 |
| 0.11948 | 0.06548 | 0.14974 | −0.01867 |
| 0.15146 | 0.07182 | 0.1901 | −0.0181 |
| 0.18671 | 0.07703 | 0.2342 | −0.01699 |
| 0.22499 | 0.08096 | 0.28153 | −0.01547 |
| 0.26604 | 0.08359 | 0.33154 | −0.01363 |
| 0.30953 | 0.08493 | 0.38364 | −0.01152 |
| 0.35506 | 0.085 | 0.43724 | −0.00922 |
| 0.40222 | 0.08385 | 0.49176 | −0.00678 |
| 0.45058 | 0.08154 | 0.54659 | −0.0043 |
| 0.49967 | 0.07816 | 0.60112 | −0.0019 |
| 0.54902 | 0.07381 | 0.65469 | 0.0003 |
| 0.59812 | 0.06861 | 0.70664 | 0.00224 |
| 0.64646 | 0.0627 | 0.75634 | 0.00379 |
| 0.69356 | 0.0562 | 0.80313 | 0.00485 |
| 0.73892 | 0.04925 | 0.84635 | 0.00535 |
| 0.78208 | 0.04199 | 0.88534 | 0.00526 |
| 0.82264 | 0.0346 | 0.91942 | 0.00458 |
| 0.86021 | 0.02731 | 0.94797 | 0.0035 |
| 0.89436 | 0.02041 | 0.97054 | 0.00226 |
| 0.92464 | 0.0142 | 0.98684 | 0.00113 |
| 0.95054 | 0.00894 | 0.9967 | 0.0003 |
| 0.97155 | 0.00485 | 1 | 0 |
| 0.98712 | 0.00204 | | |
| 0.99674 | 0.00048 | | |
| 1 | 0 | | |

The aerial mode shape of the variable-diameter blade suitable for the trans-media aircraft in this embodiment can generate a tensile force of 507.4 N when in a hovering state with blade tip Mach number of 0.529 Ma.

The underwater mode shape of the variable-diameter blade suitable for the trans-media aircraft in this embodiment can generate a thrust of 314.09 N when in an axial flow state with a forward speed of 5 m/s and the rotating speed of 500 rpm.

In the description of the present disclosure, it should be noted that the terms “first” and “second” are used for descriptive purposes only and are not to be construed as indicating or implying relative importance.

Specific examples are used herein for illustration of the principles and embodiments of the present disclosure. The description of the embodiments is merely used to help illustrate the method and its core principles of the present disclosure. In addition, those of ordinary skill in the art can make various modifications in terms of specific embodiments and scope of application in accordance with the teachings of the present disclosure. In conclusion, the content of this specification shall not be construed as a limitation to the present disclosure.

What is claimed is:

1. A variable-diameter blade suitable for a trans-media aircraft, wherein the variable-diameter blade is divided into several sub-blades in a direction from a root to a tip, all the sub-blades are named as blade root section, telescopic section and blade tip section in turn from the root to the tip, the telescopic section comprises several telescopic sections, the blade root section comprises one blade root section and the blade tip section comprises one blade tip section; any two closer sub-blades except the blade tip section are in sliding fit, and the sub-blade, closer to the blade tip section, of the any two closer sub-blades except the blade tip section is able to be accommodated in another sub-blade of the any two closer sub-blades, and the blade tip section is fixedly connected to the telescopic section which is closer to the blade tip section; the variable-diameter blade further comprises:
a telescopic rod partially located in the variable-diameter blade, the blade root section and the blade tip section each are fixedly connected to the telescopic rod, and the telescopic rod is fixedly connected to the trans-media aircraft;
a spring arranged in the telescopic rod, the spring is configured to drive the telescopic rod to extend to a maximum length;
a pulley installed on the trans-media aircraft, the pulley is closer to the blade root section and has a gap with the blade root section;
a pull rope, wherein an end of the pull rope passes through an inside of the variable-diameter blade and is fixedly connected to the blade tip section, and an other end of the pull rope is wound around the pulley; and
a driving device for driving the pulley to rotate;
a leading edge of the blade root section is a curve, and a trailing edge of the blade root section is a straight line; and a leading edge and a trailing edge of the blade tip section are both straight lines.

2. The variable-diameter blade suitable for a trans-media aircraft according to claim 1, wherein an outer wall of an end, closer to the blade root section, of each telescopic section is provided with an outer convex ring, inner walls of both ends of the blade root section and each telescopic section are provided with first limit rings and second limit rings, respectively; the first limit ring is closer to the root, and the second limit ring is closer to the tip; the outer convex ring on the sub-blade, closer to a blade tip segment, of any two closer sub-blades except the blade tip section is configured for being abutted against the first limit ring or the second limit ring on the other sub-blade of the any two closer sub-blades.

3. The variable-diameter blade suitable for a trans-media aircraft according to claim 1, wherein an axis of the telescopic rod is coaxial with a blade variable pitch axis of the variable-diameter blade; and a length direction of a part of the pull rope located in the variable-diameter blade is parallel to an axial direction of the telescopic rod.

4. The variable-diameter blade suitable for a trans-media aircraft according to claim 1, wherein when all telescopic sections are located in the blade root section, an outer wall of an end, closer to the blade root section, of the blade tip section is in smooth transition connection with an end, closer to the blade tip section, of the blade root section, and a blade composed of the blade root section and the blade tip section is configured as a blade for an underwater mode; when a length of the variable-diameter blade is in a longest state, the blade is configured as a blade for an aerial mode.

5. The variable-diameter blade suitable for a trans-media aircraft according to claim 4, wherein a shape of the blade root section is designed according to a situation that the trans-media aircraft navigates in water.
